(19) United States
(12) Patent Application Publication
(10) Pub. No.: US 2019/0021099 A1
(43) Pub. Date: Jan. 17, 2019

(54) CAPACITY OPTIMIZATION IN A COMMUNICATION NETWORK

(71) Applicant: Cable Television Laboratories, Inc., Louisville, CO (US)

(72) Inventors: Belal Hamzeh, Westminster, CO (US); Ayman Assra, Denver, CO (US)

(21) Appl. No.: 15/980,926

(22) Filed: May 16, 2018

Related U.S. Application Data
(63) Continuation of application No. 14/738,498, filed on Jun. 12, 2015, now abandoned.
(60) Provisional application No. 62/110,980, filed on Feb. 2, 2015.

(51) Int. Cl. H04W 72/12; H04L 27/00; H04L 12/26; H04W 4/08; H04L 29/08; H04W 24/02; H04L 5/00

(52) U.S. Cl. CPC H04W 72/121; H04L 27/0008; H04L 27/0012; H04L 43/0882; H04L 27/2697; H04L 67/306; H04W 24/02; H04L 5/006; H04W 4/08

(57) ABSTRACT

Systems and methods presented herein provide for optimizing or otherwise improving capacity in a communication network. In one embodiment, a method is operable in a network hub that is communicatively coupled to UEs via a plurality of communication links. Each communication link has a different data rate capacity and each UE comprises a profile that indicates its data rate capabilities (e.g., modulation schemes and the like). The method includes detecting communications of the UEs, determining the data rate capabilities of the UEs from their profiles, and determining how many different data rate capacities the network hub supports over the communication links. The method also includes grouping the UEs according to their data rate capabilities, generating a common profile for each UE group, and assigning the communication links to the UE groups based on their common profiles.

### CROSS REFERENCE TO RELATED APPLICATIONS

This patent application is a continuation patent application claiming priority to, and thus the benefit of an earlier filing date from, U.S. patent application Ser. No. 14/738,498 (filed Jun. 12, 2015), which claims priority to U.S. Provisional Patent Application No. 62/110,980 (filed Feb. 2, 2015), the contents of each of which are hereby incorporated by reference.

### BACKGROUND

A communication network typically exists to provide a plurality of end users with the ability to communicate with one another. These end users often have different types of user equipment (UEs) to communicate through the network, making it difficult for any one network to provide communications that satisfy the group as a whole. For example, in some hybrid fiber coaxial (HFC) networks employing Data Over Cable Service Interface Specification (DOCSIS), technologies such as orthogonal frequency division multiplexing (OFDM) and low density parity check (LDPC) coding have been adopted. With OFDM, spectrum usage can be customized to provide a relatively high data throughput, and LDPC increases bit density per hertz to provide higher order modulation schemes. These technologies allow for the use of different modulation “profiles” for end user cable modems (CM) so Cable Modem Termination Systems (CMTS) can adapt transmission configurations with changing channel conditions. So, each CM is assigned a profile that is optimized to its channel conditions to ensure a certain level of performance in the network. Unfortunately, the number of supported profiles in a CMTS is limited due to hardware and scheduling complexities.

### SUMMARY

Systems and methods presented herein provide for optimizing or otherwise improving capacity in a communication network. In one embodiment, a method is operable in a network hub that is communicatively coupled to UEs via a plurality of communication links. Each communication link has a different data rate capacity and each UE comprises a profile that indicates its data rate capabilities (e.g., modulation schemes and the like). The method includes detecting communications of the UEs, determining the data rate capabilities of the UEs from their profiles, and determining how many different data rate capacities the network hub supports over the communication links. The method also includes grouping the UEs according to their data rate capabilities, generating a common profile for each UE group, and assigning the communication links to the UE groups based on their common profiles.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIGS. 1A and 1B are block diagrams of an exemplary communication system.

FIG. 2 is a flowchart of an exemplary process operable within a network hub of the communication system of FIGS. 1A and 1B.

FIGS. 3 and 4 are flowcharts of exemplary processes for grouping UEs in a cable television network.

FIGS. 5-9 are tables illustrating exemplary calculations used in determining CM bit loadings.

FIG. 10 is a flowchart of an exemplary process for calculating CM bit loadings.

FIG. 11 is an exemplary cable television network employing a CMTS.

FIG. 12 is a block diagram of an exemplary computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

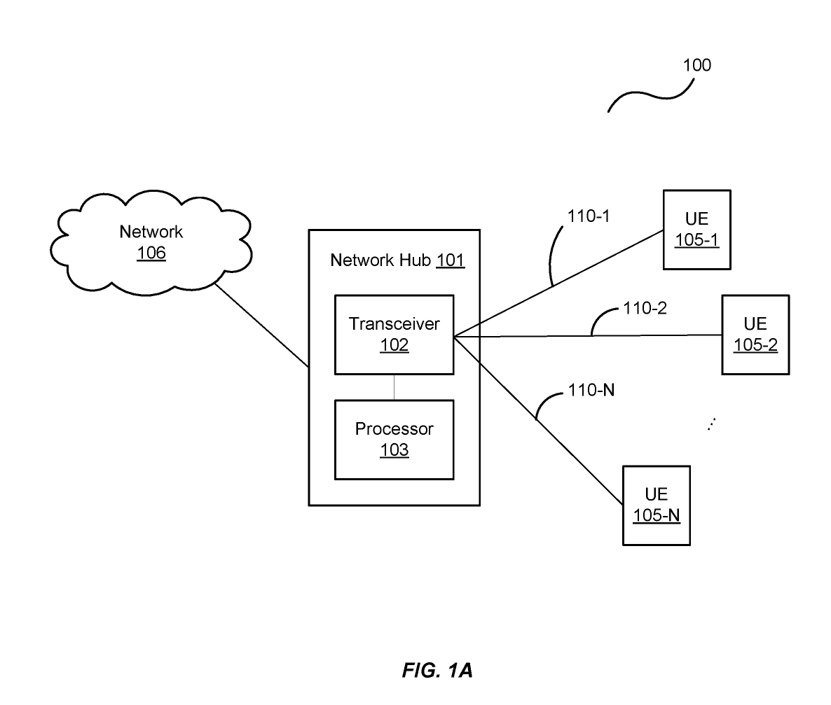

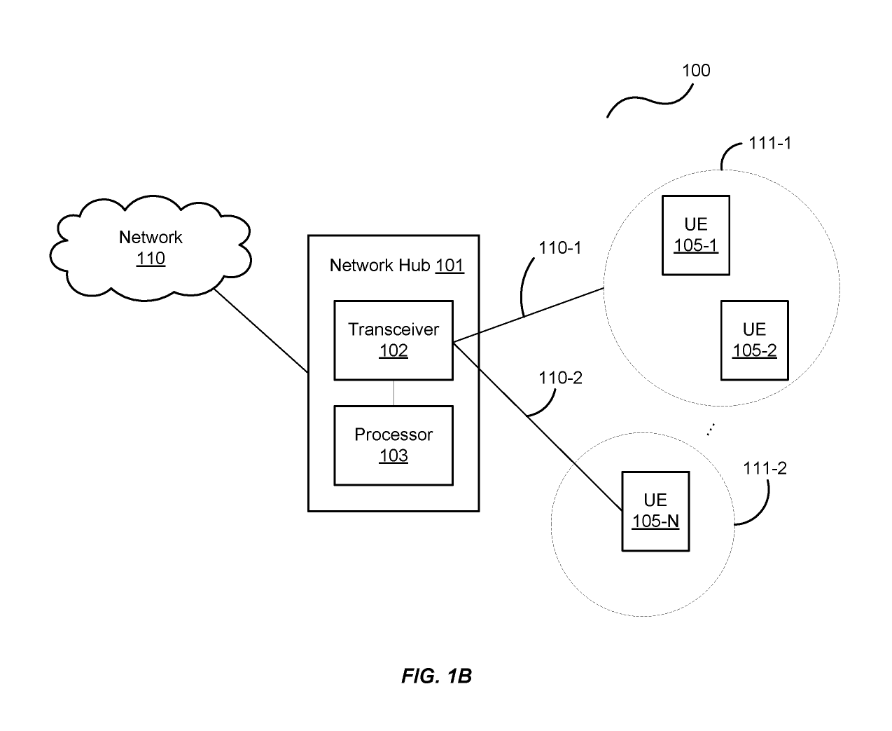

FIG. 1A is a block diagram of an exemplary communication system 100. In this embodiment, the communication system 100 includes a network hub 101 that is operable to provide communications to a plurality of UEs 105-1-105-N (where the reference “N” is merely intended to indicate an integer greater than “1” and not necessarily equal to any other “N” reference designated herein). In this regard, the network hub 101 includes a transceiver 102 that is operable to transmit data to and receive data from the UEs 105 over their respective communication links 110-1-110-N.

The UEs 105 are generally any devices that are operable to provide an end-user or subscriber with communications through a network 106, as the name “user equipment” generally implies. Examples of the UEs 105 include cell phones, computers (e.g., tablet computers, desktops, laptops, etc.), cable television modems, and the like. Accordingly, the network hub 101 and its associated transceiver 102 may be representative of any type of network element operable to provide the communications between the UEs 105 and the network 106. Examples of the network hub 101 include network elements used in cellular telephony (e.g., base stations and associated transceivers) and cable television headends. Examples of the network 106 include backend cellular telephony processing, the Internet, and the like.

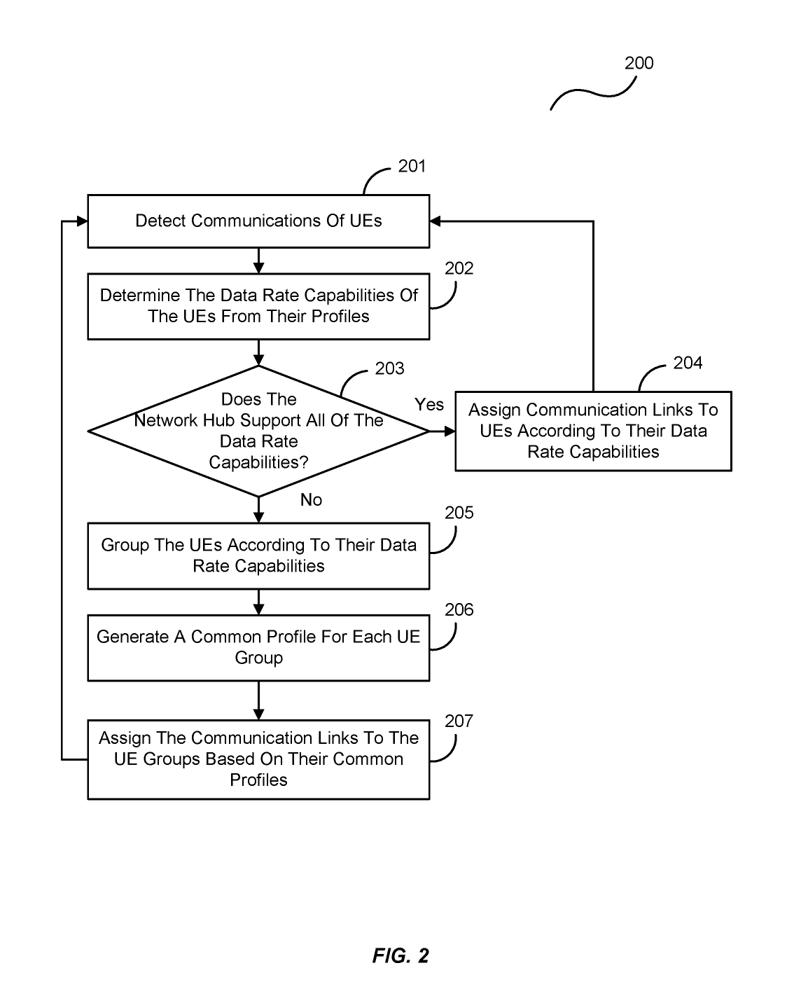

As the number and type of UEs 105 can vary within any particular communication system, so can the communication links 110 established between the transceiver 102 and the UEs 105. For example, some UEs 105 may have faster data rate capabilities than others. Accordingly, the network hub 101 may attempt to offer individual communication links 110 with those data rate capabilities. However, the systems and methods herein provide a means for optimizing communications to the UEs 105 by grouping them into comparable data rate capabilities based on their respective profiles. For example, CMs in a cable television system may have profiles that describe their various modulation schemes and data rates for subcarriers in an Orthogonal Frequency Division Multiplexing (OFDM) channel. In cellular telephony, cellular telephones may have profiles that are transmitted to the transceiver 102 to indicate its various data rate capabilities and modulation schemes. FIG. 2 illustrates one exemplary process for grouping the UEs 105 based on the profiles.

FIG. 2 is a flowchart of an exemplary process 200 operable within the network hub 101 to group UEs 105 as illustrated in FIG. 1B. Generally, the process 200 initiates with the transceiver 102 detecting and establishing communications with the UEs 105, in the process element 201. From there, the processor 103 may determine the data rate capabilities of the UEs 105 based on their associated profiles, in the process element 202.

From there, the processor 103 may determine whether the network hub 101 can support all of the data rate capabilities of the UEs 105, in the process element 203. For example, in the hybrid fiber coaxial (HFC) network in cable television, the network hub 101 may represent a cable television headend with a CMTS. Ideally, each CM (e.g., UE 105) would be assigned a profile that is optimized to its channel conditions to ensure maximum performance on a CM by CM basis. However, the cable modem termination system (CMTS) may not be equipped to handle the number of CM profiles due to hardware and scheduling complexities. Accordingly, the processor 103 is operable to group the UEs 105 according to their data rate capabilities, in the process element 205, to optimize performance for all of the connected UEs 105 in the communication system 100, as illustrated in FIG. 1B.

In grouping the UEs 105, the processor 103 is operable to generate a common profile for each group of UEs 105, in the process element 206. For example, one group of UEs 105 (e.g., the group 111-1 of UEs 105) may be operable to communicate with the network hub 101 at a data rate that is faster than another group of UEs 105 (e.g., the group 1101-2 of UEs 105). Rather than having each UE 105 employing their respective profiles operable in the network 101 with their respective data rate capabilities, the processor 103 generates a common profile for each group UEs 105 and optimizes the communications across each group of UEs 105. From there, the processor 103 assigns the communication links 110 to the various UE groups 111 based on their common profiles, in the process element 207. If, however, the network hub 101 does support all of the data rate capabilities of the UEs 105, then the processor 103 assigns a communication links 110 to the UEs according to the data rate capabilities, in the process element 204.

In either case, the processor 103 may continue to monitor the communication links 110 to the UEs 105 in case channel conditions change. For example, noisy environments can degrade communications over the communication links 110. Accordingly, the network hub 101 may downgrade the communication links 110 to lower modulation schemes and/or lower data rates to ensure effective transmission of data. As these conditions may change, the network hub 101 may upgrade the communication links 110 from time to time. Alternatively or additionally, the network hub 101 may simply be over extended or underutilized in terms of capacity. Thus, a change communication links 110 may be necessary or at least prove useful. In any case, the processor 103 may detect these changes and desire to alter the groupings 111 of the UEs 105. The processor 103 may also wish to refine the groupings 111 from time to time to further improve the communications to the UEs 105.

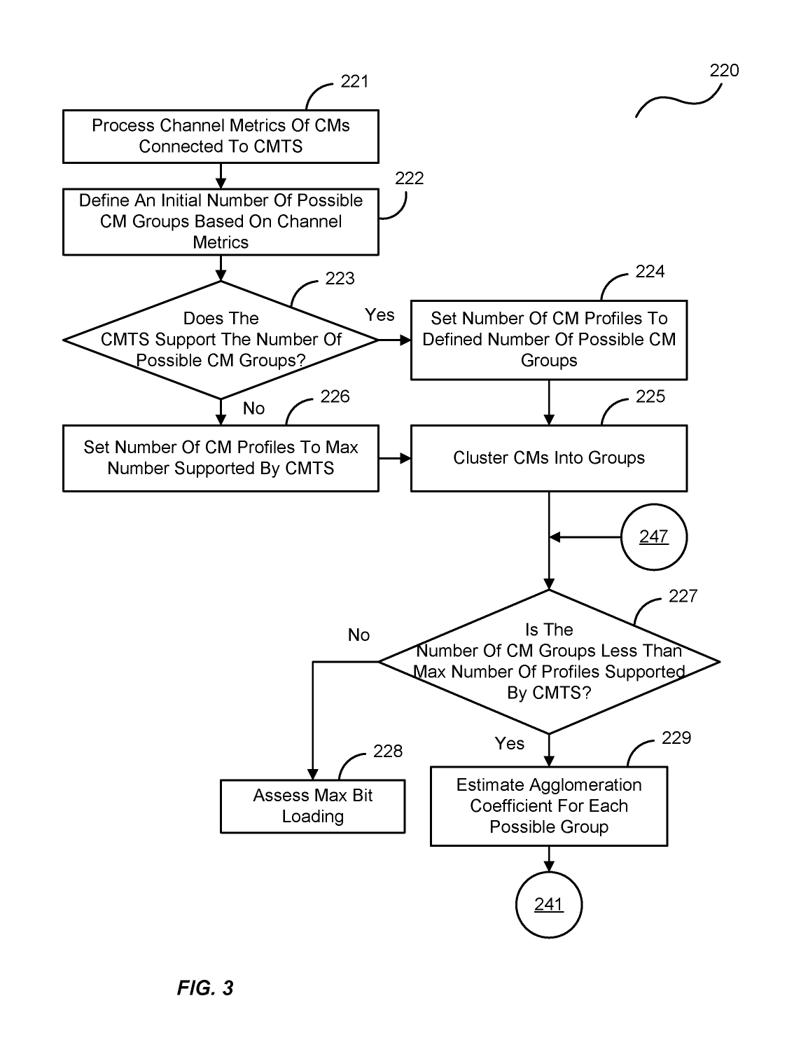

Other exemplary embodiments are shown and described below. In FIG. 3, an exemplary process of the network hub 101 is illustrated with the processor 103 refining the defined groups 111 of the UEs 105. In this exemplary embodiment, the processor 103 is operable within a CMTS of a cable television headend. In this regard, the processor 103 monitors and processes the channel metrics of the CMs connected to the CMTS via their associated communication links 110, in the process element 221. From there, the processor 103 defines an initial number of possible CM groups (e.g., a primitive group N_{Primitive-}Group) based on those channel metrics, in the process element 222. Generally, this involves determining a recommended number of groups bounded by a maximum number of groups possibly supported by the CMTS (N_{Group-CMTS}).

To determine the number of groups, a hierarchical grouping algorithm may be employed. For example, in hierarchical grouping, an agglomeration coefficient is tracked each time objects are subdivided into groups. Once a significant change in the agglomeration coefficient is observed, then the optimum number of primitive groups (N_{Primitive-Group}) determined by the algorithm is reached. After defining the optimum or desired number of groups, the next process is to assign CMs into the defined groups. Generally, CMs with much similarity in their channel metrics are assigned to the same groups, as it tends to maximize system capacity by maximizing the possible bit loading per CM profile. Then, the groups are optimized.

Before the groups are optimized, a determination is made whether the CMTS supports the number of possible CM groups, in the process element 223. If the CMTS can support the initial number of primitive groups, then the processor establishes the number of CM profiles to that number, in the process element 224. Otherwise, the processor 103 establishes the number of CM profiles to be the maximum number supported by the CMTS, in the process element 226. In either case, the processor 103 clusters the CMs into groups to begin optimizing those groups.

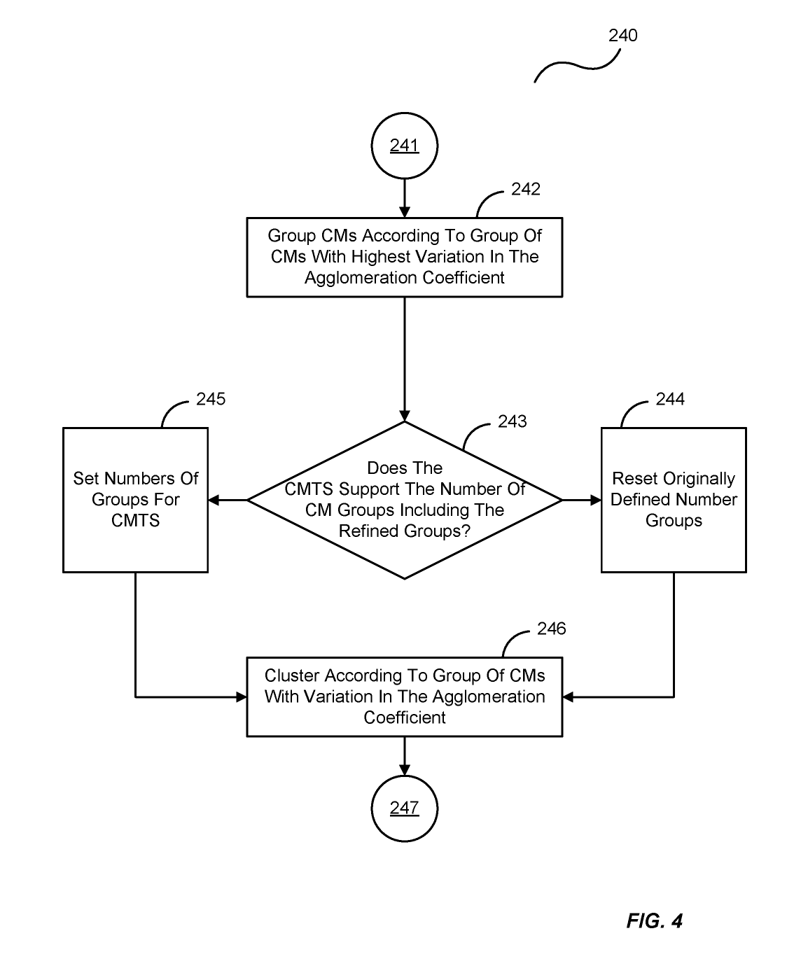

In one embodiment, a K-means algorithm is employed by the processor 103 to cluster the CMs into the groups based on similar channel metrics. The output of such results in N_{Group} number of groups with some number of CMs in each group. From there, the processor 103 refined the groups, in the process element 227, by determining whether the number of CM groups is less than the max number of profiles supported by the CMTS. For example, after creating the primitive groups N_{Primitive-Group}, the processor 103 further refines the groups to reduce discrepancy within a group and maximize system capacity. If N_{Primitive-Group} is less than the number of profiles possibly supported by the CMTS (N_{Group-CMTS}) (or the target number of groups), then the processor 103 refines the primitive grouping of N_{Primitive-Group} by estimating the agglomeration coefficients for each created primitive group, in the process element 229. The processor 103 then selects the primitive group with a maximum variation in the agglomeration coefficient for additional clustering or division (via process element 241 into exemplary process 240 of FIG. 4). Otherwise, the processor 103 assesses the max bit loading of the communication links 110 and establishes those rates to the UEs 105, in the process element 228.

The flowchart of FIG. 4 illustrates an exemplary process 240 of the processor 103. In this embodiment, the processor 103 hierarchically groups the CMs according to the group of CMs with the highest variation in the agglomeration coefficient, in the process element 242. For example, the processor 103 may hierarchically group the primitive group with the highest agglomeration coefficient to identify the number of groups created in the refinement process (N_{Primitive-Group-Refined}). From there, the processor 103 determines whether the CMTS supports a number of CM groups including the refined groups, in the process element 243. That is, the processor 103 calculates the new number of primitive groups as:

if N_{Primitive-Group}+N_{Primitive-Group-Refined}−1<=N_{Group-CMTS}.

Then, the processor 103 resets the originally defined number as:

N_{Primitive-Group}=N_{Primitive-Group}+N_{Primitive-Group-Refined}−1, in the process element 244.

Otherwise, the processor 103 establishes the refined primitive group as:

N_{Primitive-Group-Refined}=N_{Group-CMTS}−N_{Primitive-Group}+1. The processor 103 also establishes the number of groups for the CMTS as:

N_{Primitive-Group}=N_{Group-CMTS}, in the process element 245.

These calculations ensure that the total number of primitive groups do not exceed that maximum number of profiles that can be supported by the CMTS (i.e., the original groups plus any new ones identified within the group with the highest agglomeration coefficient equaling N_{Primitive-Group}+N_{Primitive-Group-Refined}−1). From there, in the process element 246, the processor 103 clusters according to the group of CMs with the highest variation in the agglomeration coefficient, for example, via a K means clustering using N_{Primitive-Group-Refined}. This results in a new set of primitive groups that is equal to or less than the maximum number of profiles that can be supported by the CMTS. Generally, the same process is repeated across all primitive groups (new and old) until the target number of groups is achieved which is equal to the maximum number of profiles (i.e., groups) that can be supported by the CMTS (i.e., or some number of profiles defined by the operator) such that the maximum bit loading (i.e., process element 228 of FIG. 3 via process element 247) can be achieved in the groups.

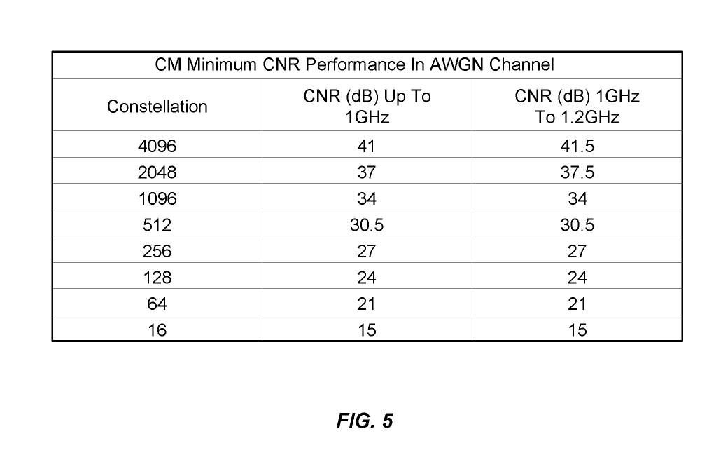

To achieve the maximum bit loading, the processor 103 first assumes that a given spectrum is divided into C subchannels, each with a fixed bandwidth (e.g., 6 MHz). Given that the CMs report the average channel signal to noise (CNR) measurements of each subchannel to the CMTS, CMs with similar frequency responses are grouped into the same profile. And, for each profile, a list of modulation orders (e.g., constellations) is defined over all subchannels. The assignment rule is defined such that the frequency regions with high average SNR values are assigned high modulation orders for downstream (DS) transmissions, and vice versa, as illustrated in the table of FIG. 5.

Then, the processor 103 goes about maximizing the bit loading for an OFDM symbol using, for example, a DS profile definition in the DOCSIS 3.1. The objective is to increase the system throughput during DS transmissions, thereby enhancing the capacity of the communication system 100 (i.e., in a cable television network embodiment). In doing so, let

$${x}_{cl} = \{ \begin{matrix}1 , & if the BW interval of CM l starts at subchannel c \\ 0 , & otherwise\end{matrix} \\ and \\ {a}_{\hat{c} cl} = \{ \begin{matrix}1 , & \begin{matrix}if the BW interval of CM l starting at \\ subchannel c also covers subchannel \hat{c}\end{matrix} \\ 0 , & otherwise\end{matrix}$$

Generally, there are two constraints on the spectrum allocation and bit loading problem of the DOCSIS DS 3.1. First, for each CMl, there is just one subchannel cl at which a corresponding bandwidth (BW) interval can start. For example, Σ_{cl}x_{cl}=1 ∀l∈L, where L is the total number of CMs. Second, there is no overlap between the BW intervals assigned to different. For example,

Σ_{cl}a_{ĉcl}≤1∀ĉ∈C.

Then, assume w_{cl} is a number of loaded bits over the BW assigned to CMl and starting at subchannel c. Then the total number of bits for an OFDM symbol is given by

Wₜₒₜ=Σ_{cl}w_{cl}x_{cl}.

Then, the processor 103 can formulate a model with an objective function using constraints as follows:

$${max}_{\{ {x}_{cl} ∈ \{ 0 , 1 \} \}} {W}_{tot} ,$$

such that

Σ_{c}x_{cl}=1∀l∈L

Σ_{cl}a_{ĉcl}x_{cl}≤1∀ĉ∈C

### EXAMPLE

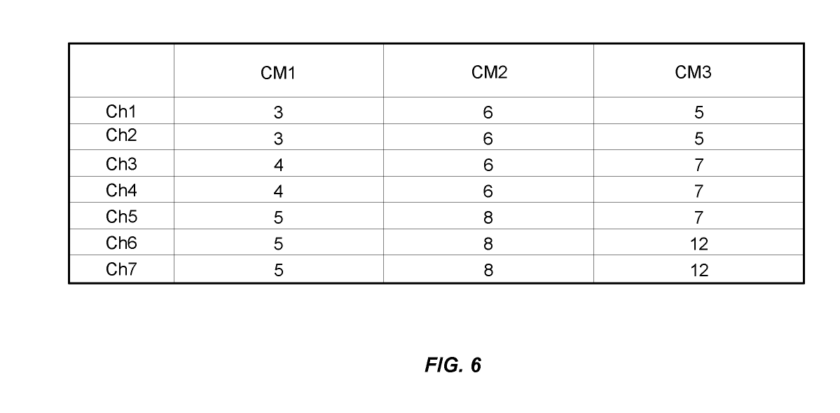

Consider a DOCSIS DS system with a frequency spectrum divided into 7 subchannels, with each subchannel being 6 MHz bandwidth. Now, assume the DS system serves 3 CMs. The profile definition for each CM is given by the table in FIG. 6. Then, assume that a ratio between target throughputs of different CMs is given by

R₁:R₂:R₃=1:3:3,

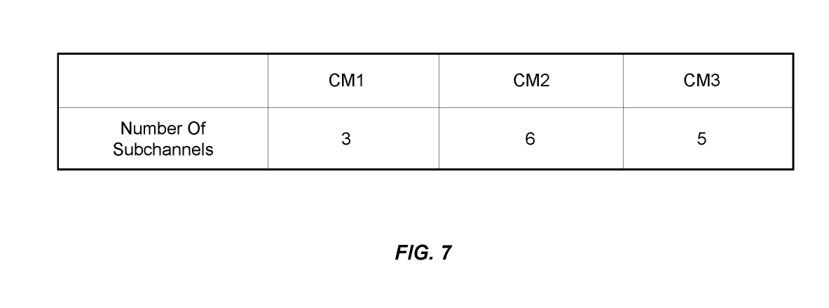

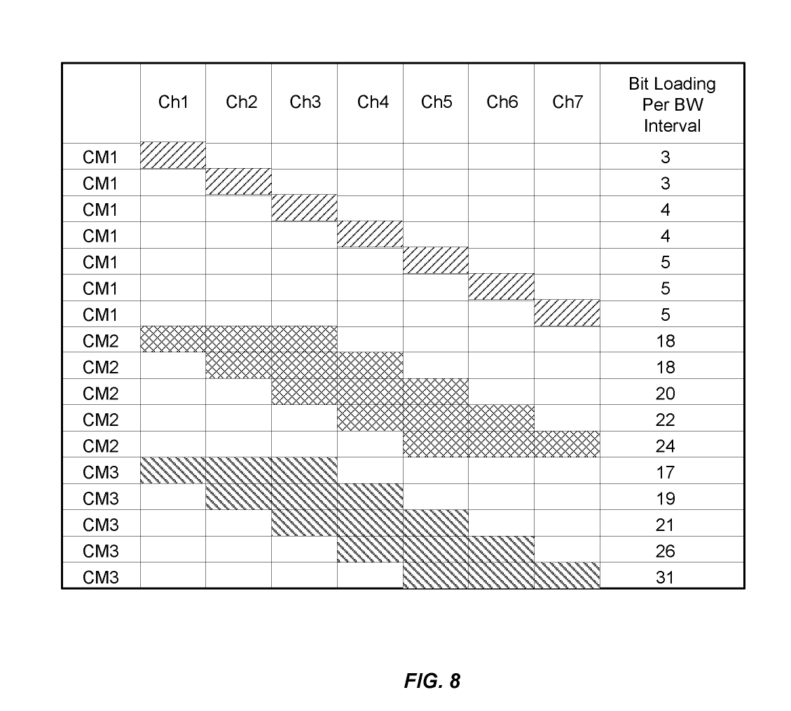

and that the bandwidth spectrum can be allocated among the three CMs according to that ratio as illustrated in FIG. 7. Then, the bit loading scenarios can be calculated based on a given profile definition of the table in FIG. 6 and a number of sub channels (i.e., the BW interval) for each CM illustrated in the table of FIG. 7. These exemplary bit loading scenarios are illustrated in the table of FIG. 8.

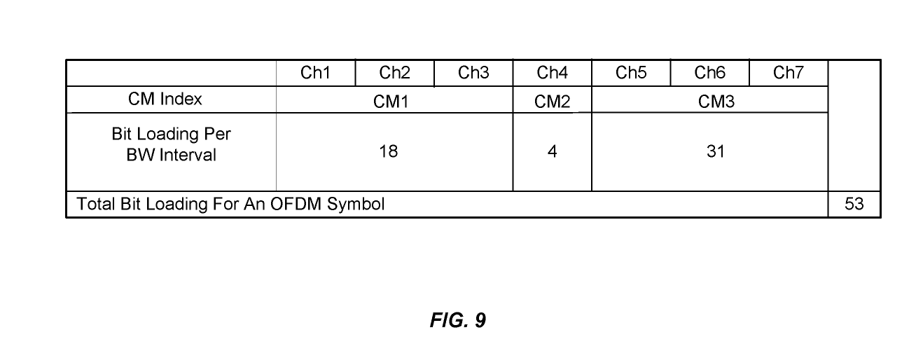

Thus, the number of possible BW allocations for CM1, CM2 and CM3 are 7, 5, and 5 possibilities, respectively. And, by trying all possible combinations of the BW intervals for the 3 CMs, maximum bit loading can be achieved via the following spectrum allocations illustrated in the table of FIG. 9.

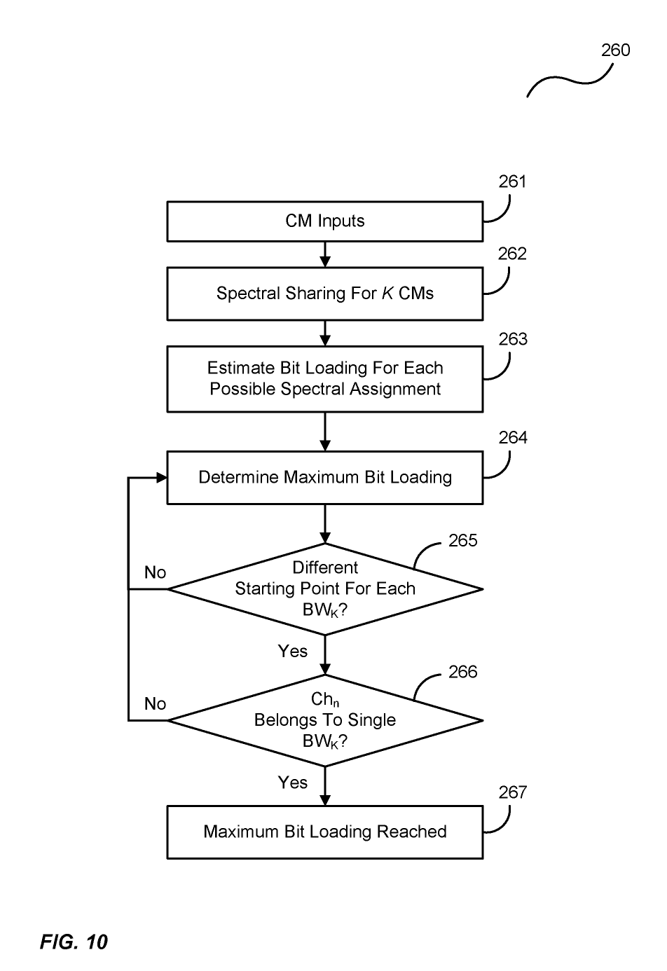

FIG. 10 illustrates one exemplary bit loading process 260 that may be used in the process element 228 of FIG. 3. In this embodiment, the processor 103 is assumed as being implemented with a CMTS in a cable television network so as to align with the example illustrated above and thereby provide ease in understanding to the reader. However, it should be noted that this exemplary bit loading algorithm may be implemented with any type of data transmitting/receiving devices (i.e., UEs 105) that in grouped for the purposes of capacity optimization.

With that said, the process 260 initiates with the CM inputs being processed by the processor 103, in the process element 261. For example, the CMTS being connected to a plurality of CMs will initiate communications with the CMs and determine their profiles and the channel characteristics, as exemplarily illustrated in the table of FIG. 5. Then, in the process element 262, the processor 103 determines the spectrum sharing for K number of CMs connected to the CMTS, as exemplarily illustrated in the tables of FIGS. 6 and 7. From there, the processor 103 estimates the bit loading for each possible spectral assignment, in the process element 263, and determines the maximum bit loading, in the process element 264, as exemplarily illustrated in the tables of FIGS. 8 and 9.

To ensure that maximum bit loading has been achieved, the processor 103 determines whether a different starting point exist for each bandwidth of each channel, in the process element 265. If not, the processor continues to determine the maximum bit loading, in the process element 264. Otherwise, the processor determines whether a particular channel belongs to a single bandwidth, in the process element 266. If not, the processor again returns to determine the maximum bit loading, in the process element 264. Otherwise, the processor 103 determines that the maximum bit loading has been reached, in the process element 267, and ends until another maximum bit loading calculation is required (e.g., when channel conditions change, other UEs 105 are added to the system, etc.).

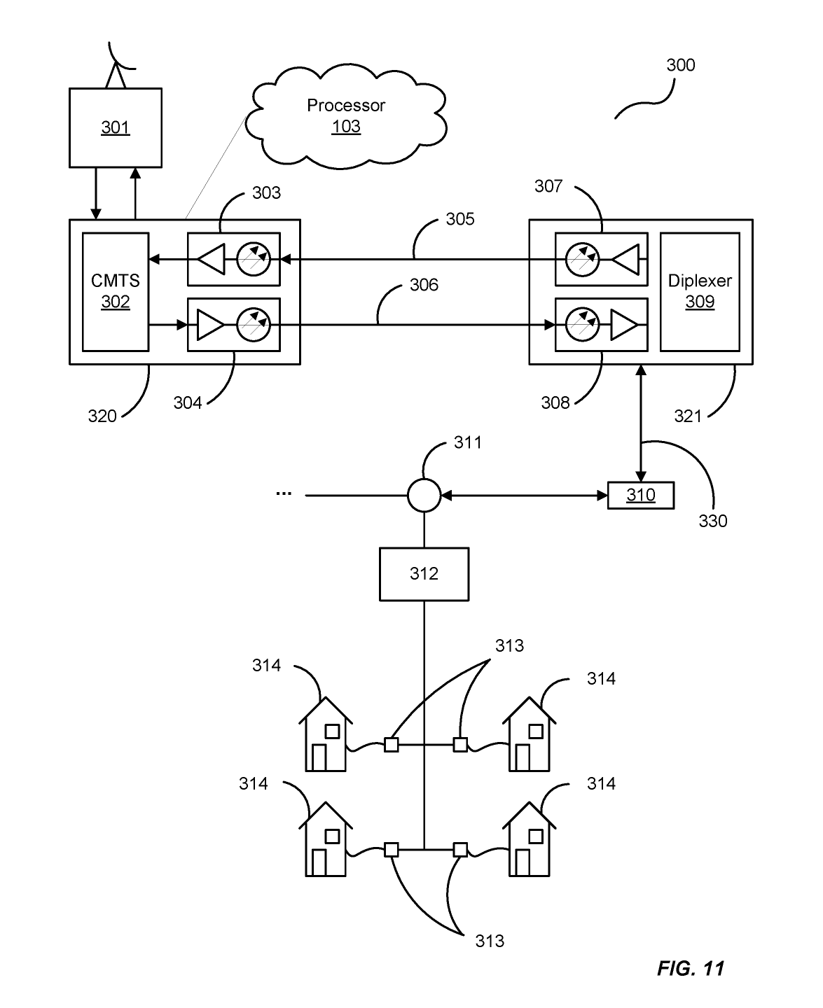

FIG. 11 is a block diagram of one exemplary communication system 300 employing the UE grouping and bit loading techniques concepts described herein. For example, the video compression/decompression concepts disclosed herein may be implemented in a cable television communication system that employs RF signaling techniques across a substantial amount of RF spectrum. An upstream link of the cable television communication system, in this embodiment, provides high speed data services being delivered over devices conforming to the Data Over Cable Service Interface Specification (DOCSIS) specification. The communication system 300 includes a headend 301 configured with an upstream hub 320. The hub 320 is coupled to a downstream node 321 via optical communication links 305 and 306.

The hub 320 includes a Cable Modem Termination System (CMTS) 302, an electrical to optical converter 303, and an optical to electrical converter 304. The node 321 is similarly configured with an optical to electrical converter 308 and an electrical to optical converter 307. The headend 301 is generally the source for various television signals. Antennas may receive television signals that are converted as necessary and transmitted over fiber optic cables 305 to the hub 320. Several hubs may be connected to a single headend 301 and the hub 320 may be connected to several nodes 321 by fiber optic cable links 305 and 306. The CMTS 302 may be configured in the headend 301 or in the hub 320. The fiber optic links 305 and 306 are typically driven by laser diodes, such as Fabry Perot and distributed feedback laser diodes.

Downstream, in homes/businesses are devices (e.g., UEs 105 (called the Cable Modems (CM; not shown). A CM acts as a host for an Internet Protocol (IP) device such as personal computer. Transmissions from the CMTS 302 to the CM are carried over the downstream portion of the cable television communication system generally from 54 to 860 MHz. Downstream digital transmissions are continuous and are typically monitored by many CMs. Upstream transmissions from the CMs to the CMTS 302 are typically carried in the 5-42 MHz frequency band, the upstream bandwidth being shared by the CMs that are on-line. However, with greater demands for data, additional frequency bands and bandwidths are continuously being considered and tested, including those frequency bands used in the downstream paths.

The CMTS 302 connects the local CM network to an Internet backbone. The CMTS 302 connects to the downstream path through the electrical to optical converter 304 that is connected to the fiber optic cable 306, which in turn, is connected to the optical to electrical converter 308 at the node 321. The signal is transmitted to a diplexer 309 that combines the upstream and downstream signals onto a single cable. The diplexer 309 allows the different frequency bands to be combined onto the same cable. The downstream channel width in the United States is generally 6 megahertz with the downstream signals being transmitted in the 54 to 860 MHz band. Upstream signals are presently transmitted between 5 and 42 MHz, but again other larger bands are being considered to provide increased capacity. So, the variably assigned bit resolution concepts herein may be particularly advantageous. However, the invention is not intended to be limited to any particular form of communication system.

After the downstream signal leaves the node 321, the signal is typically carried by a coaxial cable 330. At various stages, a power inserter 310 may be used to power the coaxial line equipment, such as amplifiers or other equipment. The signal may be split with a splitter 311 to branch the signal. Further, at various locations, bi-directional amplifiers 312 may boost and even split the signal. Taps 313 along branches provide connections to subscriber's homes 314 and businesses.

Upstream transmissions from subscribers to the hub 320/headend 301 occur by passing through the same coaxial cable 330 as the downstream signals, in the opposite direction on a different frequency band. The upstream signals are sent typically utilizing Quadrature Amplitude Modulation (QAM) with forward error correction. The upstream signals can employ any level of QAM, including 8 QAM, 32 QAM, 64 QAM, and even 4096 QAM. Modulation techniques such as Synchronous Code Division Multiple Access (S-CDMA) and Orthogonal Frequency Division Multiple Access (OFDMA) can also be used. Of course, any type of modulation technique can be used, as desired.

Transmissions, in this embodiment, are typically sent in a frequency/time division multiplexing access (FDMA/TDMA) scheme, as specified in the DOCSIS standards. The diplexer 309 splits the lower frequency signals from the higher frequency signals so that the lower frequency, upstream signals can be applied to the electrical to optical converter 307 in the upstream path. The electrical to optical converter 307 converts the upstream electrical signals to light waves which are sent through fiber optic cable 305 and received by optical to electrical converter 303 in the node 320.

Those skilled in the art should readily recognize that the invention is not intended to be limited to the examples disclosed herein. For example, the invention should not be limited to any particular number of frequency bands segmented, any number of bits of resolution during quantization, and/or any frequency bandwidth of an analog signal. Nor should the invention be limited to any particular form of analog signal. That is, the inventive concepts disclosed herein may be used in a variety of communication systems regardless of bandwidth considerations.

One example of where the CM grouping and bit loading calculations could be implemented in the communication system 300 would be with the CMTS 302 as mentioned above. Alternatively, the processor 103 could be implemented in a “cloud” service such that a plurality of CMTSs 302 could take advantage of the CM grouping and bit loadings. For example, a plurality of multisystem operators (MSOs) may have a number of CMTSs and the network, each connected to a number of differing CMs. The processor 103 could be implemented as a network device (e.g., an Internet server) that interfaces with a plurality of CMTSs and provides CM grouping a bit loading calculations for each. In this regard, the processor 103, through another network (e.g., the Internet) would continually monitor the channel conditions for each CMTS 302 subscribing to the processor 103.

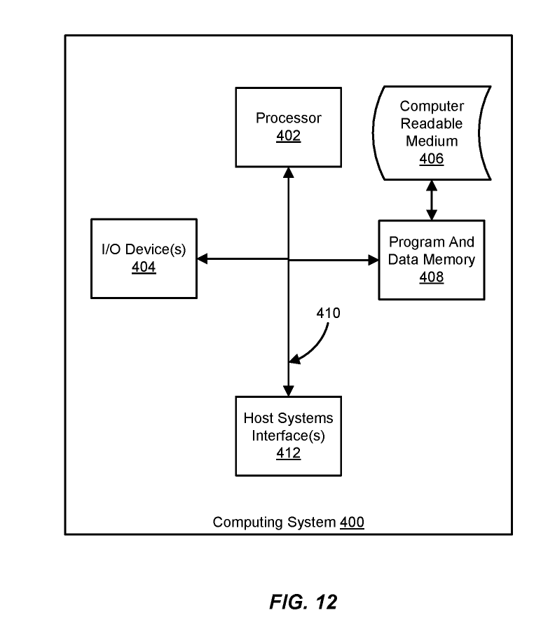

Additionally, the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 12 illustrates a computing system 400 in which a computer readable medium 406 may provide instructions for performing any of the methods disclosed herein.

Furthermore, the invention can take the form of a computer program product accessible from the computer readable medium 406 providing program code for use by or in connection with a computer or any instruction execution system. For the purposes of this description, the computer readable medium 406 can be any apparatus that can tangibly store the program for use by or in connection with the instruction execution system, apparatus, or device, including the computer system 400.

The medium 406 can be any tangible electronic, magnetic, optical, electromagnetic, infrared, or semiconductor system (or apparatus or device). Examples of a computer readable medium 406 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 400, suitable for storing and/or executing program code, can include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution. Input/output or I/O devices 404 (including but not limited to keyboards, displays, pointing devices, etc.) can be coupled to the system either directly or through intervening I/O controllers. Network adapters may also be coupled to the system to enable the computing system 400 to become coupled to other data processing systems, such as through host systems interfaces 412, or remote printers or storage devices through intervening private or public networks. Modems, cable modem and Ethernet cards are just a few of the currently available types of network adapters.

What is claimed is:

1. A system, comprising:
a server communicatively coupled to a first network hub,
wherein:
the first network hub is communicatively coupled to a first plurality of user equipment (UEs) via a first plurality of communication links;
each UE comprises a profile that indicates its modulation order,
the server detects communications between the UEs and the first network hub, groups the UEs into an initial plurality of groups based on the detected communications, and, until a number of UE profiles supported by the first network hub is reached, optimizes the initial plurality of groups by estimating an agglomeration coefficient of modulation orders for each group of the UEs based on the UE profiles, selecting a group from the initial plurality of groups having a largest agglomeration coefficient, and dividing the selected group into at least two groups of UEs.

2. The system of claim 1, wherein:
the server further determines that the initial plurality of groups of UEs can be expanded.

3. The system of claim 1, wherein:
the server further determines the modulation orders of the UEs from their profiles.

4. The system of claim 1, wherein:
the server further determines that the initial plurality of groups of UEs is greater than that which the first network hub supports, and establishes a number of groups of the UEs as that which the first network hub supports.

5. The system of claim 1, wherein:
the server further determines that the initial plurality of groups of UEs is equal to that which the first network hub supports, and maximizes bit loading for each group.

6. The system of claim 5, wherein, in maximizing the bit loading for each group:
the server further assigns modulation orders to each group based on signal to noise ratios of the UEs in each group communicating over the first plurality of communication links.

7. The system of claim 1, wherein:
the first network hub comprises a Cable Modem Termination System (CMTS) employing Data Over Cable Service Interface Specification (DOC SIS) communications to implement the communication links.

8. The system of claim 1, wherein:
the server is communicatively coupled to a second network hub,
wherein:
the second network hub is communicatively coupled to a second plurality of user equipment (UEs) via a second plurality of communication links;
each UE of the second plurality comprises a profile that indicates its modulation order,
the server detects communications between the UEs of the second plurality and the second network hub,
groups the UEs of the second plurality into a second initial plurality of groups based on the detected communications, and, until a number of UE profiles supported by the second network hub is reached, optimizes the second initial plurality of groups by estimating an agglomeration coefficient of modulation orders for each group of the UEs of the second plurality based on the UE profiles of the UEs of the second plurality, selecting a group of UEs of the second plurality from the second initial plurality of groups having a largest agglomeration coefficient, and dividing the selected group of UEs of the second plurality into at least two groups of UEs.

9. A method operable in a server communicatively coupled to a first network hub, wherein the first network hub is communicatively coupled to a first plurality of user equipment (UEs) via a first plurality of communication links and each UE comprises a profile that indicates its modulation order, the method comprising:
detecting communications between the UEs and the first network hub;
grouping the UEs into an initial plurality of groups based on the detected communications; and,
until a number of UE profiles supported by the first network hub is reached, optimizing the initial plurality of groups by estimating an agglomeration coefficient of modulation orders for each group of the UEs based on the UE profiles, selecting a group from the initial plurality of groups having a largest agglomeration coefficient, and dividing the selected group into at least two groups of UEs.

10. The method of claim 9, further comprising:
determining that the initial plurality of groups of UEs can be expanded.

11. The method of claim 9, further comprising:
determining the modulation orders of the UEs from their profiles.

12. The method of claim 9, further comprising:
determining that the initial plurality of groups of UEs is greater than that which the first network hub supports; and
establishing a number of groups of the UEs as that which the first network hub supports.

13. The method of claim 9, further comprising:
determining that the initial plurality of groups of UEs is equal to that which the first network hub supports; and
maximizing bit loading for each group.

14. The method of claim 13, wherein, in maximizing the bit loading for each group, the method further comprises:
assigning modulation orders to each group based on signal to noise ratios of the UEs in each group communicating over the first plurality of communication links.

15. A non-transitory computer readable medium operable in a server communicatively coupled to a first network hub, wherein the first network hub is communicatively coupled to a first plurality of user equipment (UEs) via a first plurality of communication links and each UE comprises a profile that indicates its modulation order, the computer readable medium comprising instructions that, when executed by a processor of the server, directs the processor to:
detect communications between the UEs and the first network hub;
group the UEs into an initial plurality of groups based on the detected communications; and,
until a number of UE profiles supported by the first network hub is reached, optimize the initial plurality of groups by estimating an agglomeration coefficient of modulation orders for each group of the UEs based on the UE profiles, selecting a group from the initial plurality of groups having a largest agglomeration coefficient, and dividing the selected group into at least two groups of UEs.

16. The computer readable medium of claim 15, further comprising instructions that direct the processor to:
determine that the initial plurality of groups of UEs can be expanded.

17. The computer readable medium of claim 15, further comprising instructions that direct the processor to:
determine the modulation orders of the UEs from their profiles.

18. The computer readable medium of claim 15, further comprising instructions that direct the processor to:
determine that the initial plurality of groups of UEs is greater than that which the first network hub supports; and
establish a number of groups of the UEs as that which the first network hub supports.

19. The computer readable medium of claim 15, further comprising instructions that direct the processor to:
determine that the initial plurality of groups of UEs is equal to that which the first network hub supports; and
maximize bit loading for each group.

20. The computer readable medium of claim 19, wherein, in maximizing the bit loading for each group, the computer readable medium further comprises instructions that direct the processor to:
assign modulation orders to each group based on signal to noise ratios of the UEs in each group communicating over the first plurality of communication links.

21. A system, comprising:
a network hub communicatively coupled to a plurality of user equipment (UEs) via a plurality of communication links,
wherein each UE comprises a profile that indicates its modulation order and the network hub detects communications of the UEs over the plurality of communication links, groups the UEs into an initial plurality of groups based on the detected communications, and, until a number of UE profiles supported by the network hub is reached, optimizes the initial plurality of groups by estimating an agglomeration coefficient of modulation orders for each group of the UEs based on the UE profiles, selecting a group from the initial plurality of groups having a largest agglomeration coefficient, and dividing the selected group into at least two groups of UEs.
